(19) United States
(12) Patent Application Publication
(10) Pub. No.: US 2014/0304036 A1
(43) Pub. Date: Oct. 9, 2014

(54) MONETIZING ACCESS FOR DEMONSTRATIONS AND RUNNING SOFTWARE IN THE CLOUD WITHOUT REBUILDING THE SOFTWARE APPLICATION TO A WEB APPLICATION

(71) Applicant: Cromozon, Inc., Napa, CA (US)

(72) Inventor: Sven Johan Mikael Sjoblom, Napa, CA (US)

(73) Assignee: Cromozon, Inc., Napa, CA (US)

(21) Appl. No.: 14/248,190

(22) Filed: Apr. 8, 2014

Related U.S. Application Data
(60) Provisional application No. 61/809,679, filed on Apr. 8, 2013.

(51) Int. Cl. G06Q 30/02

(52) U.S. Cl. CPC G06Q 30/0269; G06Q 30/0201; G06Q 30/0203
USPC 705/7.32; 705/7.29

(57) ABSTRACT

A web based administration console is provided to enable access and use software applications online through a browser. A hosting system for providing access to online usage of software comprises one or more servers set up to provide a platform having a virtual environment. The servers have vendor software installed thereon for running by the servers in the virtual environment. The platform and its installed software are remotely accessible over a network to multiple simultaneous users who have registered their user information. The user information may be used to customize the experience with tailored tutorials, questions and guidelines when using the software. Contact and usage information is delivered back to the software vendor. Software selected by users is run on the servers, each user interacting in the virtual environment remotely over the network with the software, either as a software demonstration, education or as subscription service.

### CROSS-REFERENCE TO RELATED APPLICATION

This application claims priority under 35 U.S.C. 119(e) from prior U.S. provisional application No. 61/809,679, filed Apr. 8, 2013.

### TECHNICAL FIELD

The present invention relates generally to computer network services and cloud computing, together with associated server and virtual machine systems, for providing access over a network to computing resources, including for online demonstration of software and/or software as a service.

### BACKGROUND ART

Online demonstrations yield wide access to potential users and purchasers, particularly when done over networks such as the Internet. However, providing access to computer demonstrations of sophisticated software, without purchase, can be an involved and expensive process. Currently, a vendor offering software for purchase in order to offer online demonstrations has to have access to an online network at great cost in time, effort, equipment, and money. A way is needed to provide online computer demonstrations of software in a manner that is neither time consuming nor overly expensive for vendors.

One problem for vendors is that existing solutions only give access to one-by-one demonstration of software in the cloud using virtual machine (VM) technology. As an example, if a vendor expects to have 1,000 visitors at their website at the same time in a marketing campaign that wishes to try their software through a VM, the vendor need 1,000 VMs to run parallel.

Further, if a vendor wishes to provide their software as a subscription service for cloud computing, the vendor has to rebuild their software applications into web applications to make it software as a Service (SaaS) compatible. This is a great cost in time, effort, equipment, and money. What is needed is a way to provide a software service through a browser window that is neither time consuming nor overly expensive for vendors.

If a vendor wishes to customize each demonstration to a prospective customer, or teach a subject to a student, they need to have staff next to the user to create a user-oriented experience. This is expensive, time consuming and cannot be done on a large scale based on the limitation of staff versus the large number of potential customers that want to try and/or use a software application. What is needed is a way to select each user in different categories and segments automatically and build individual demonstrations for every unique user to create the optimal demonstration environment without having staff involved which will reduce cost and time for the vendor.

If a vendor wishes to understand what all users do in the software when using the software, and what all users like about various functions and features, it is expensive and time-consuming to conduct usability studies to receive such data. It is impossible to conduct such usability study without having the user data connected with the usage of the software. What is needed are ways to automatically have every user leave their opinions about the software without manual interaction with the user. To automate the questionnaire and monitoring process of usage of every user will reduce the cost and time and make it possible for a vendor to receive 100% feedback for the first time from all users trying or using the software.

### SUMMARY DISCLOSURE

A web based administration console is provided to enable access, use and administrate software applications online through a browser window. A hosting system for providing access to online usage of software comprises one or more servers set up to provide a platform having a virtual environment. The servers have vendor software uploaded and installed thereon for running by the servers in the virtual environment. The platform and its installed software are remotely accessible over a network to multiple simultaneous users who have provided user contact information.

A computer server implemented method provides access to online usage of software. The method begins with providing a platform having a virtual environment on one or more servers of a hosting system accessible to users over a network, the servers having vendor software uploaded and installed thereon for running by the servers in the virtual environment. One or more users are registered with the hosting system by providing user contact information to the platform, which in turn supplies the contact information to those vendors of the particular software accessed by each user. The vendor software selected by one or more simultaneous registered users is run on the servers, each user interacting remotely over the network with the software in the virtual environment provided by the platform.

Users provide their contact information via a prospect management page accessed from the platform over the network. The hosting system may include means for triggering electronic mail to the user, based upon the user contact information from and about a vendor of particular software accessed by that user on the platform. The contact information may also form a basis for supplying a user-specific tutorial over the platform, generating user-specific questions for user feedback on the software, and selecting specific advertisements that are displayed in the virtual environment to a specific user.

The software is accessible to a user as a demonstration with user interaction with the software over the network in the virtual environment provided by the platform. How long a time a user spends using the accessed software may be tracked and the information obtained used as an item of feedback to the vendor of that particular software. The hosting system can include means for invoicing a vendor for each demonstration access by a user of its software. Alternatively, in a SaaS version, the software may be accessible to a user with fully functional interaction with the software over the network in the virtual environment provided by the platform, for example as a subscription service or for training or education purposes. Still further, a user's interaction with specific software accessed over the network in the virtual environment provided by the platform may be tracked so as to record what the user does with that software, including for example any one or more of what tools in the software are employed, how frequently such tools are used, and what kinds of key strokes are employed to make use of such software tools. Such recorded information can be compiled for feedback and statistics to the vendor of the software for further software development. The virtual environment provided by the platform can include a display area for targeted advertising.

This invention allows multiple users to use a software application simultaneously using only one VM which eliminates the bottle neck if more than one user wishes to use a software application from a software vendor online. An additional advantage is that software as a service (SaaS) can be implemented directly without rebuilding a software application into a web application. This is the result in enabling the system to use multiple instances (concurrent users) at the same VM.

### BRIEF DESCRIPTION OF THE DRAWINGS

FIG. 1 shows a general schematic of the various components of a hosting system for providing access to online usage of software.

FIG. 2 shows a sample of one possible design for a user interface in a server-provided platform having a virtual environment.

FIG. 3 shows various steps during a demonstration.

FIG. 4 shows various steps of a first embodiment of a computer server implemented method for online demonstration of software.

FIG. 5 shows various steps of a second embodiment of a computer server implemented method for Software as a Service (SaaS).

### DETAILED DESCRIPTION

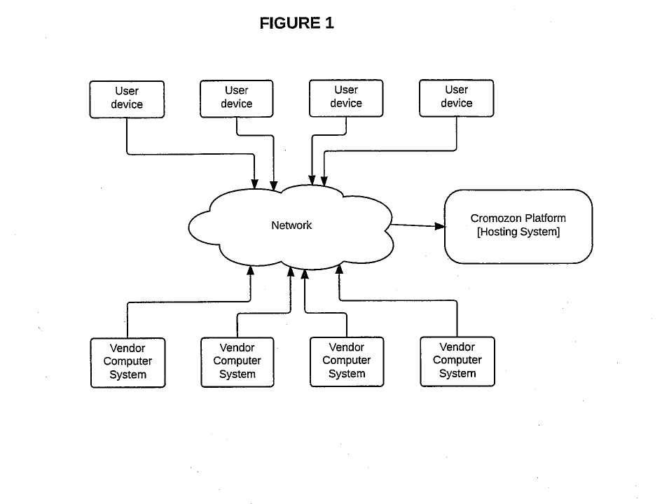

With reference to FIG. 1, a hosting system for providing access to online usage of software has one or more software products is uploaded from vendor computer systems via a network, such as the Internet, and installed on that hosting system. The hosting system provides a platform having a virtual environment offering dedicated online access to the software via a portal that requires user contact information. User devices, using a web browser can access the hosting system via the network after entry through the portal and run the software on the hosting system as either a demonstration or software as a service (SaaS) in a virtual environment, such as a virtual desktop. The platform is built to allow multiple users to access the same instance. The vendor can request 2 or thousands of concurrent users to use the software at the same time. The software can be easily accessed by the user device without putting constraints on either the user device or the vendor computer systems.

The software can be either regular desktop software or server software applications. Simple virtual machines (VM's) only provide an online demonstration for desktop software applications. This invention allows the system to install server software applications with additional and connected client/desktop applications to show how server software interacts with its clients in a real environment. A tab will display the server software and additional tabs the clients that are controlled by the server. When actions are made in the server software that affects a client, the actions can be seen immediately when clicking the client tab. This way the system showcases how server and client software interacts together in a cloud environment and in a single window.

The hosting system includes computer servers set up as virtual machines or virtual desktops or other environments to provide the demonstration and/or SaaS services for the vendor.

In practice, a vendor uploads a software application to the hosting system that can be used and/or tested. The software can have full or limited functionality.

A user device may be analyzed by the hosting system to determine the ability of the user device to run the demonstration. Communication may be initiated by the hosting system informing the user device of problems in accessing the demonstration and possible solutions to the problems. Thus allowing a user to correct these problems and view the demonstration.

User access is provided to the software demonstrations through a portal requiring user contact information—Prospect Management—when accessing the hosting system or a specific demonstration. This information may include such things as name, physical address, email address, and organization or affiliation. This information is the foundation of the intelligence controlling and customizing the demonstration mode for each individual user.

Each user in the demonstration mode will receive tailor made tutorials for each individual user. The vendor defines the different prospects they aim to target, and create tutorials for each target. The user chose which category of prospects they belong to in various dropdown questionnaires in the prospect management module. Questions will vary depending on what software application is going to be demonstrated. Once the demonstration mode is on, selected tutorials will be provided to the selected user.

Each user will receive tailor made trigger emails for each individual user. The vendor defines the different prospects they aim to target, and create marketing messages for each target. The user chose which category of prospects they belong to in various dropdown questionnaires in the prospect management module. Messages will vary depending on what the ISV wishes to communicate to the prospect. It may be various offers of discounts to simple courtesy messages.

Each user will receive tailor made usability questions during and after the demonstration session is over. This is what we call “studio Questions”. The vendor defines the different prospects they aim to target, and create survey questions for each target. The user chose which category of prospects they belong to in various dropdown questionnaires in the prospect management module. Questions will vary depending on what the ISV wishes to find out from the prospect. It may be questions if the user has tried certain tools and features in the software or simply if they like it or not.

Options may be provided to users allowing them to download the demonstration to the user's device, purchase the software from the hosting system, or connect to a vendor computer system for direct communication with the vendor.

Once a user end the demonstration session, an intelligence report compile all data collected during the time the user tried the software. The data in the report may vary but in most cases the data will include contact information of the user, what the user liked about the software (studio questions), date and time when the demonstration was made, how long time the user spent using the software and sometimes what they did in the software. The intelligence report is delivered to the vendors sales and marketing department so they can follow up the customer.

The cost to the vendor would be a charge each time one of the vendor's demonstrations is viewed and an intelligence report with all session data is delivered to the vendor. A onetime set up fee is charged.

This is an online service offering either demonstrations or Software as a Service (SaaS) to existing or prospective customers or of Independent Software Vendors (ISV). The SaaS is useful not only for paid subscribers, but also for working in an educational environment when, for example, training someone to use the particular vendor software or its latest upgrade version. When using SaaS in an educational situation, tutorials may be provided specific to whether the user is a novice user of that software, a new user who is familiar with a competitor's software, or an existing user attempting to learn about new features in an upgrade version. These can further be tailored to a specific class of user. Tracking of the use of the software in an educational environment can allow user hints to pop-up when an unused feature is available that could improve performance with the software.

The vendors provide their software application that is then installed on virtual machines (VM) on the platform. Once the VM is setup a link is provided to the ISV that the ISV can use on their websites and/or in their email marketing campaigns. Once the link is clicked, it will take the user to the system, initiating either the online demonstration or the SaaS version.

We define the demonstration product as a marketing tool because of the following reasons:
Once the online demonstration (the session) is activated the user have voluntarily provided their contact details in a prospect management module.
Once the prospect management module is completed will marketing emails—trigger emails—be sent to the prospective customer.
Once the online demonstration (the session) start, usability questions—Studio Questions—will be asked to find out what the prospective customer like or what they did when using the software during the session.
Once the online demonstration (the session) is completed, the lead data is compiled into an Intelligence report. Data in this report includes contact information of the user, what the user liked about the software (studio questions), date and time when the demonstration was made, how long time the user spent using the software and sometimes what they did in the software. The intelligence report is delivered to the vendors sales and marketing department so they can follow up the customer. The intelligence report is delivered back to the ISV either as an email or direct into a CRM system.
The ISV is now able to contact every user that has tried the software increasing the chance of selling their software unlike any other type of marketing tool.

We define the SaaS product as a cloud software tool because of the following reasons:
Once the software is uploaded onto the platform it can be used exactly the same way as if it would be downloaded and installed on a local computer.
Once the user start using the SaaS product they will login at their personal profile using security and storage provided as directed by the ISV.
The software application can be used from any type of device using a browser and have access to internet, from anywhere.
Even if the software application is not a web application that normally is used to power SaaS, the platform deliver the software application to the user with exactly the same user experience as if it would be a web application.
Even if the software application is a web application that normally is used to power SaaS, the functionality and features of the platform, the user data is still delivered to the vendor as if it would have been a non-SaaS software application.

Version 1 is an online demonstration service, while Version 2 is a “Software as a Service” (SaaS) service.

Using our system the software can be utilized at its full potential instead of an online demonstration service. The ISV can decide whether they wish to offer a demonstration or a SaaS agreement with their customers.

### Demonstration Agreement

The ISV has the ability to provide users storage space [at an additional cost]. This enables users to return to the demonstration session using the same data that was input in previous sessions.

### SaaS Agreement

The ISV can provide a SaaS of their software using the platform without rebuilding the software to a web application. The SaaS can be used as a subscription service offered and sold by the ISV. The price will vary depending on the usage, software, and security.

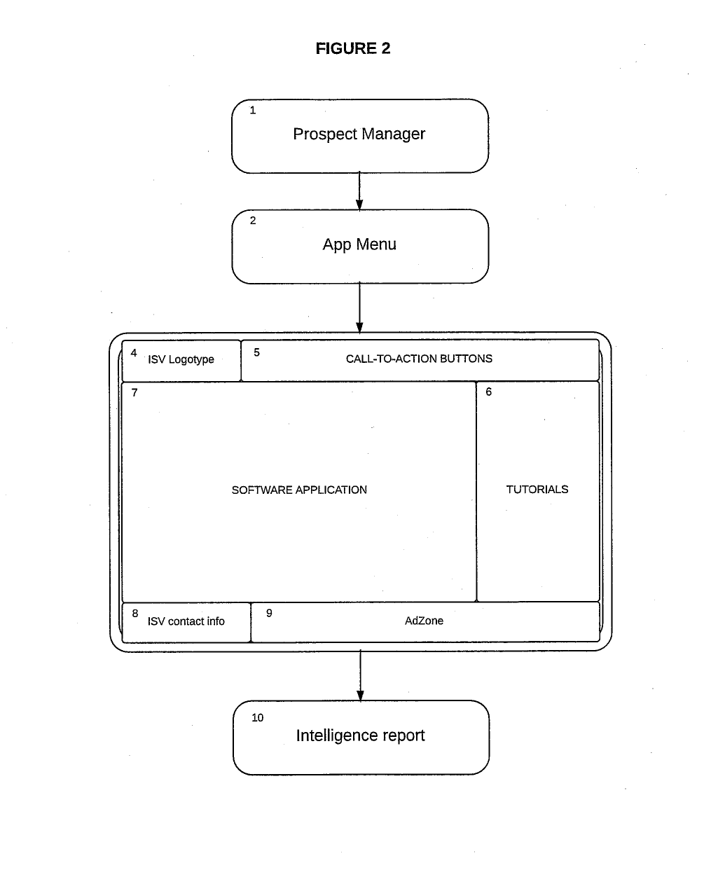

With reference to FIG. 2, a sample of one possible design for the user interface is seen. The design can be created together with the ISVs graphic designers, following the guidelines and directions from their corporate identity handbook. The user will have a seamless experience going from the ISVs homepage to our platform. The look, feel, and touch of the design shall be identical to the ISVs corporate identity.

1: The sessions start with a registration form, also defined as the prospect management. The Independent Software Vendor (ISV) decides how many questions, and what questions shall be asked. The data is provided on a voluntary basis and may include name, email address, phone, organization or affiliation, position, geographic location etc. There may be more or less information. This information is the foundation of the intelligence controlling and customizing the online session for each individual user.

2: Some ISVs have more than one software application they wish to demonstrate. In these cases, we will have a separate HTML page with all of their applications listed (App Menu) so the user can click on the software they wish to use.

3: We create a skin, imitating the ISVs own corporate identity and website design.

4: The ISVs logotype.

5: This section will include “Call-To-Action” buttons. The ISV chooses what buttons they wish to have. It may be BUY which takes the user to the ISVs web store. It may be HELP which takes them to the help section of the ISVs website. It may be CHAT, activating the chat function of the ISV. There could also be links to social media sites i.e. Facebook, LinkedIn, blogs, etc.

6: The tutorial section can be plain text, video, flash, or links to the ISVs website. Using data from the prospect management module, the system can custom build the online session and give each user selected tutorials depending on what the user work with, previous experiences of the same or similar software applications, geographic and language selections, etc. The tutorial is shown next to the software application to help the prospective customer understand the software they are testing as well as guide them to tools and features that applies to the individual user. As an example, an accounting software demonstration can have three different users evaluating the software from the same company. The CFO usually pulls profit and loss statements from the system which means this person will receive tutorials how to do that. The bookkeeper records receipts and creates invoices on a daily basis which means that tutorials speaking about this work are displayed. A warehouse manager pulls inventory reports and creates export invoices from the accounting software system and will therefore receive tutorials speaking about this. The same software has different people with different needs. The customization of the tutorials may also be usedin any type of educational environment whereas different people on different levels of knowledge can be helped at the level each individual is at.

7: The online demonstration will be the full version of the software that the ISV market.

Version 1: The up/download of files will be disabled. The demo version may have sample databases that the user can play around with. The user can add and remove data in the demo version. When the session is completed all data will be lost and the system is reset and ready for the next user.

Version 2: Same as Version 1, however the up/download and save function will be enabled. Security will also be added.

A few minutes into the session, a pop-up menu will appear with questions (Studio Questions). The questions may reflect the user's opinion about the software or if they have tried certain tools in the software. This is an optional feature for the ISV. Every user will be exposed to this usability survey.

Once the session is over a pop-up menu will appear with questions (Studio Questions). The questions may reflect the user's opinion about the software or if they have tried certain tools in the software. This is an optional feature for the ISV. Every user will be exposed to this usability survey.

8: This section will include contact data for the ISV, privacy policy, or anything else the ISV would like to add. It will also include our logo “Powered by Cromozon”

9: This section will be an advertising section—AdZone—that will deliver selected ads to selected users [selected in the prospect management].

10: When the session is completed and closed, all data is compiled into an intelligence report delivered back to the ISV. The report includes contact information of the user, what the user liked about the software (studio questions), date and time when the demonstration was made, how long time the user spent using the software and—in some cases—what they did in the software. The data in the intelligence report vary from software application to software application, and from ISV to ISV, depending on what kind of questions has been asked in the prospect management module as well as in the studio questions. The intelligence report is delivered to the vendors sales and marketing department so they can follow up the customer. The intelligence report is delivered back to the ISV either as an email or direct into a CRM system.

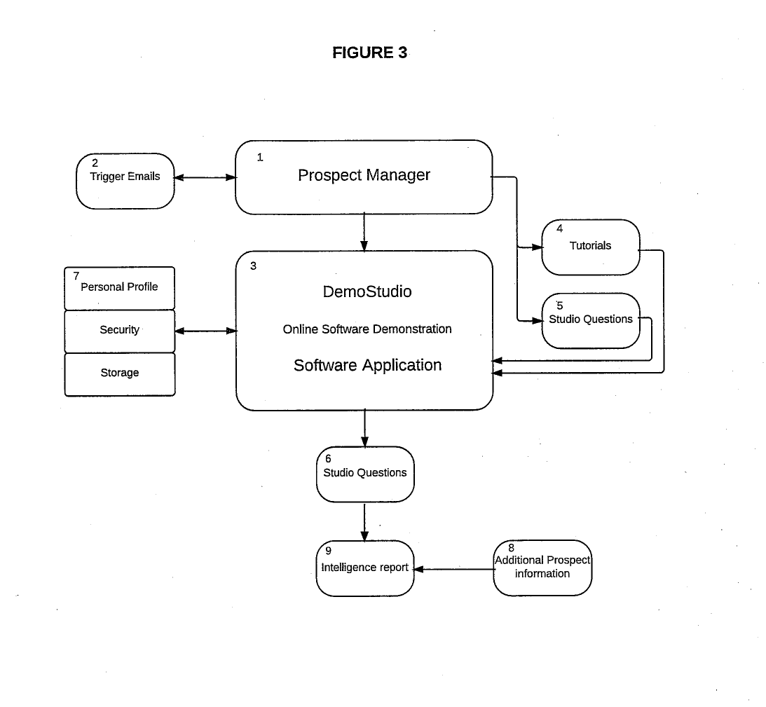

With reference to FIG. 3, various steps during a demonstration are seen.

1: The sessions start with a registration form, also defined as the prospect management. The Independent Software Vendor (ISV) decides how many questions, and what questions shall be asked. The data is provided on a voluntary basis and may include name, email address, phone, organization or affiliation, position, geographic location etc. There may be more or less information. This information is the foundation of the intelligence controlling and customizing the online session for each individual user.

2: The ISV can customize different messages in trigger emails to different users. This is an optional feature for the ISV. The different messages are selected using the data in the prospect management module. The messages are created by the ISV as well as pre-defined by the ISV who shall receive it. As an example, if a question has been answered in the prospect management module that the user is currently using a previous version of the software application they are going to use in the online session, and the purpose of using the online session is to try “next year” or the “latest version” of the software to “check and compare”, a trigger email message may be to discount an upgrade to this user if the upgrade is done within a certain time frame. A trigger email can also be a courtesy message saying thank you for using the software and preparing the user that someone will contact them via email or phone to follow up if any questions need answers.

3: The online demonstration will be the full version of the software that the ISV market.

Version 1: The up/download of files will be disabled. The demo version may have sample databases that the user can play around with. The user can add and remove data in the demo version. When the session is completed all data will be lost and the system is reset and ready for the next user unless the ISV have purchased storage to enable the save mode.

Version 2: Same as Version 1, however the up/download and save function will be enabled. The SaaS can be used as a subscription service offered and sold by the ISV. The price will vary depending on the usage, software, and security.

4: The tutorial section can be plain text, video, flash, or links to the ISVs website. Using data from the prospect management module, the system can custom build the online session and give each user selected tutorials depending on what the user work with, previous experiences of the same or similar software applications, geographic and language selections, etc. The tutorial is shown next to the software application to help the prospective customer understand the software they are testing as well as guide them to tools and features that applies to the individual user. As an example, an accounting software demonstration can have three different users evaluating the software from the same company. The CFO usually pulls profit and loss statements from the system which means this person will receive tutorials how to do that. The bookkeeper records receipts and creates invoices on a daily basis which means that tutorials speaking about this work are displayed. A warehouse manager pulls inventory reports and creates export invoices from the accounting software system and will therefore receive tutorials speaking about this. The same software has different people with different needs. The customization of the tutorials may also be used in any type of educational environment whereas different people on different levels of knowledge can be helped at the level each individual is at.

5: A few minutes into the session, a pop-up menu will appear with questions (Studio Questions). The questions may reflect the user's opinion about the software or if they have tried certain tools in the software. This is an optional feature for the ISV. Every user will be exposed to this usability survey.

6: Once the session is over a pop-up menu will appear with questions (Studio Questions). The questions may reflect the user's opinion about the software or if they have tried certain tools in the software. This is an optional feature for the ISV. Every user will be exposed to this usability survey.

7: In version 2 of this product there will be storage capabilities for the user. This enables the user to come back and continue trying the software, using the same data that was input in the previous session. The personal profile must be setup to give the user the storage space needed for this operation. The user will also be able to upload files'into the testing environment.

8: The ISV will have the option to add data about the user in the intelligence report (9) outside the scope of data collected in the testing environment. We can provide data from social media sites i.e. Facebook, Linkedln, etc, as well as add credit and criminal report data that is acquired from third party vendors.

9: When the session is completed and closed, all data is compiled into an intelligence report delivered back to the ISV. The report includes contact information of the user, what the user liked about the software (studio questions), date and time when the demonstration was made, how long time the user spent using the software and—in some cases—what they did in the software. The data in the intelligence report vary from software application to software application, and from ISV to ISV, depending on what kind of questions has been asked in the prospect management module as well as in the studio questions. The intelligence report is delivered to the vendors sales and marketing department so they can follow up the customer. The intelligence report is delivered back to the ISV either as an email or direct into a CRM system. The ISV will be billed a certain amount for the lead information that is provided back to them also referred to as PayPerDemo (PPD).

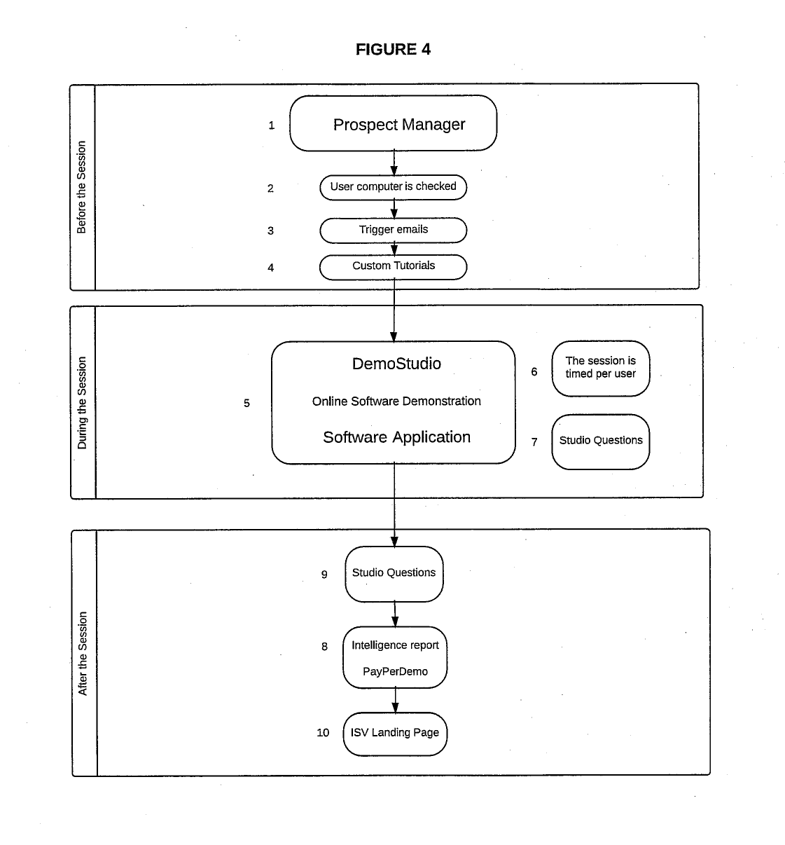

With reference to FIG. 4, various steps for Version 1, online demonstrtion only, are seen. The ISV is the customer of ours. There will be references to the USER which is the person that enter our system and want to use a software application we run on our platform for our customers (the ISV's).

1: The sessions start with a registration form, also defined as the prospect management. The Independent Software Vendor (ISV) decides how many questions, and what questions shall be asked. The data is provided on a voluntary basis and may include name, email address, phone, organization or affiliation, position, geographic location etc. There may be more or less information. This information is the foundation of the intelligence controlling and customizing the online session for each individual user. As an option for the ISV the system can block users coming from certain IP addresses, email domains, or companies.

A returning user shall not have to answer all questions again as all data is already collected for that particular user. Terms & Conditions check box will apply.

2: A user device may be analyzed by the hosting system to determine the ability of the user device to run the demonstration. Communication may be initiated by the hosting system informing the user device of problems in accessing the demonstration and possible solutions to the problems. Thus allowing a user to correct these problems and view the demonstration.

3: The ISV can customize different messages in trigger emails to different users. This is an optional feature for the ISV. The different messages are selected using the data in the prospect management module. The messages are created by the ISV as well as pre-defined by the ISV who shall receive it. As an example, if a question has been answered in the prospect management module that the user is currently using a previous version of the software application they are going to try in the online session, and the purpose of using the online session is to try “next year” or the “latest version” of the software to “check and compare”, a trigger email message may be to discount an upgrade to this user if the upgrade is done within a certain time frame. A trigger email can also be a courtesy message saying thank you for using the software and preparing the user that someone will contact them via email or phone to follow up if any questions need answers.

4: The tutorial section can be plain text, video, flash, or links to the ISVs website. Using data from the prospect management module, the system can custom build the online session and give each user selected tutorials depending on what the user work with, previous experiences of the same or similar software applications, geographic and language selections, etc. The tutorial is shown next to the software application to help the prospective customer understand the software they are testing as well as guide them to tools and features that applies to the individual user. As an example, an accounting software demonstration can have three different users evaluating the software from the same company. The CFO usually pulls profit and loss statements from the system which means this person will receive tutorials how to do that. The bookkeeper records receipts and creates invoices on a daily basis which means that tutorials speaking about this work are displayed. A warehouse manager pulls inventory reports and creates export invoices from the accounting software system and will therefore receive tutorials speaking about this. The same software has different people with different needs. The customization of the tutorials may also be used in any type of educational environment whereas different people on different levels of knowledge can be helped at the level each individual is at.

5: The demo session starts, using all features explained in the PRODUCT DESCRIPTION.

6: As soon as the demo session starts, the system keeps track of how long time the user has been using the software application. If the user has created a profile and returned to the session, the number of returned sessions will be recorded together with each individually recorded numbers of seconds/minutes per session. This data is provided in the intelligence report to the ISV after the session is complete (8).

7: A few minutes into the session, a pop-up menu will appear with questions (Studio Questions). The questions may reflect the user's opinion about the software or if they have tried certain tools in the software. This is an optional feature for the ISV. Every user will be exposed to this usability survey.

8: Once the session is over a pop-up menu will appear with questions (Studio Questions). The questions may reflect the user's opinion about the software or if they have tried certain tools in the software. This is an optional feature for the ISV. Every user will be exposed to this usability survey.

9: When the session is completed and closed, all data is compiled into an intelligence report delivered back to the ISV. The report includes contact information of the user, what the user liked about the software (studio questions), date and time when the demonstration was made, how long time the user spent using the software and—in some cases—what they did in the software. The data in the intelligence report vary from software application to software application, and from ISV to ISV, depending on what kind of questions has been asked in the prospect management module as well as in the studio questions. The intelligence report is delivered to the vendors sales and marketing department so they can follow up the customer. The intelligence report is delivered back to the ISV either as an email or direct into a CRM system. The ISV will be billed a certain amount for the lead information that is provided back to them also referred to as PayPerDemo (PPD).

10: Optional for the ISV. The last part will be a landing page at the ISVs website.

### Data Collection

This is a selection of data that can be collected from the user during the process explained above. Questions are different from application to application, and from ISV to ISV. They are decided by the ISV depending on what they wish to have added into the intelligence report:
Prospect Management
   Who the user is
   What they work with
   Where they are Located
   Their experience using this software
   Language selection
Studio questions during and after the session is over.
   What they did
   what they liked
   if they tried certain tools
   the quality of the demonstration
How long time the user spent using the software application.

### Data Delivery

The ISV will receive an intelligence report after each completed session (8). The data can either be sent directly into the ISVs CRM system or delivered as individual emails. The data can be delivered immediately after the session ends, or on a daily/monthly basis.

### Time Out

If and when the system is idle for a number of minutes, it will close down. To make sure data is not lost for registered users, it will be auto saved on their profile before the session closes down. The non-registered users will lose all data once the session is closed.

### Concurent Users (CCU)

Simple virtual machines (VM's) only provide one-by-one sessions. We enable the system to share resources and run parallel instances (sessions) on the same VM on the platform. The system will have to be built so it can scale to as many CCU's as the ISV wishes to have. The more CCU's, the more hardware power is necessary.

### Server Software Applications

Simple virtual machines (VM's) only provide an online demonstration for desktop software applications. This invention allows the system to install server software applications with additional and connected client/desktop applications to show how server software interacts with its clients in a real environment. A tab will display the server software and additional tabs the clients that are controlled by the server. When actions are made in the server software that affects a client, the actions can be seen immediately when clicking the client tab. This way the system showcases how server and client software interacts together in a cloud environment.

### Connectivity

The session should be accessible by all WIN OS (including mobile), APPLE OS running Windows, Android, iPhone, iPad.

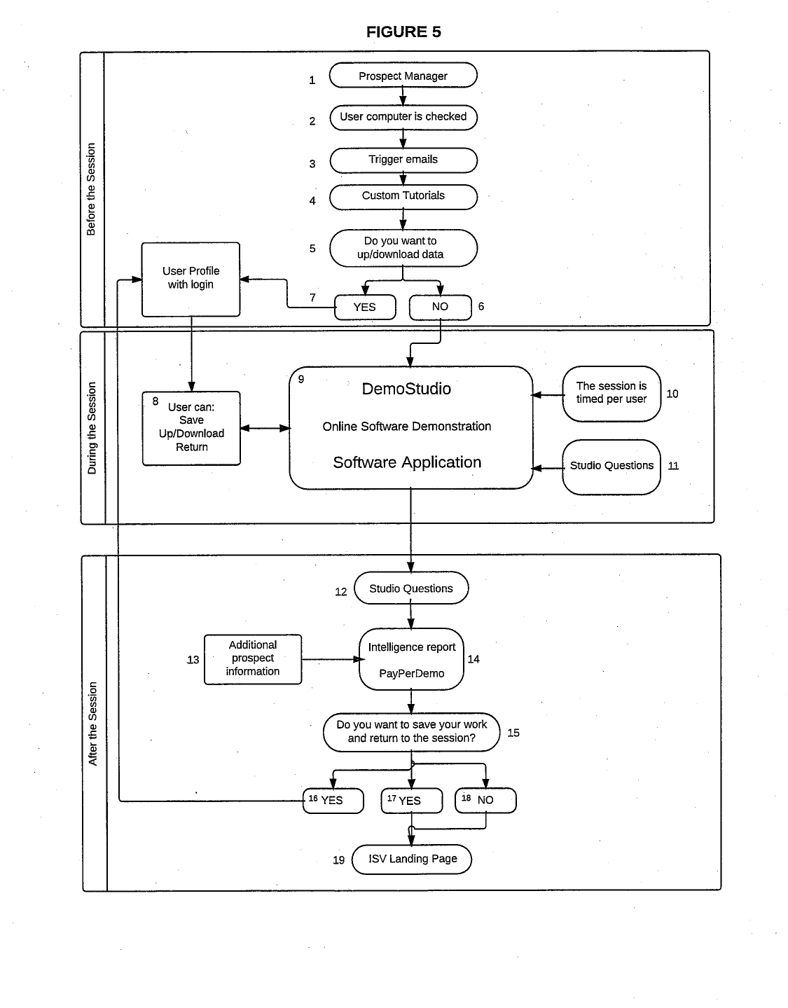

With reference to FIG. 5, various steps for Version 2, Software as a Service (SaaS), are seen. The ISV is our customer. There will be references to the user which is the person that enters our system and wants to use a software application that we run on our platform for our customers (the ISV's).

1: The user clicks on a link, taking them to our platform, starting the online session. The first time a user enter the system they will go through a registration process to receive login details. If the user return to the system and already have login details, this will be used to enter the system to use the software [see item 7 below].

A new user will immediately have a visual of the portal page but can't use it yet. The background will be faded and the registration menu will be high-lighted. We call the registration function “the prospect management” in this document.

The Independent Software Vendor (ISV) decides how many questions, and what questions shall be asked. The data is provided on a voluntary basis and may include name, email address, phone, organization or affiliation, position, geographic location etc. There may be more or less information. This information is the foundation of the intelligence controlling and customizing the online session for each individual user.

As an option for the ISV the system can block users coming from certain IP addresses, email domains, or companies. A returning user shall not have to answer all questions again as all data is already collected for that particular user. Terms & Conditions check box will apply.

2: A user device may be analyzed by the hosting system to determine the ability of the user device to run the online session. Communication may be initiated by the hosting system informing the user device of problems in accessing the demonstration and possible solutions to the problems. Thus allowing a user to correct these problems and manage the online session.

3: The ISV can customize different messages in trigger emails to different users. This is an optional feature for the ISV. The different messages are selected using the data in the prospect management module. The messages are created by the ISV as well as pre-defined by the ISV who shall receive it. As an example, if a question has been answered in the prospect management module that the user is currently using a previous version of the software application they are going to use in the online session, and the purpose of using the online session is to try “next year” or the “latest version” of the software to “check and compare”, a trigger email message may be to discount an upgrade to this user if the upgrade is done within a certain time frame. A trigger email can also be a courtesy message saying thank you for trying the software and preparing the user that someone will contact them via email or, phone to follow up if any questions need answers.

4: The tutorial section can be plain text, video, flash, or links to the ISVs website. Using data from the prospect management module, the system can custom build the online session and give each user selected tutorials depending on what the user work with, previous experiences of the same or similar software applications, geographic and language selections, etc. The tutorial is shown next to the software application to help the prospective customer understand the software they are testing as well as guide them to tools and features that applies to the individual user. As an example, an accounting software demonstration can have three different users evaluating the software from the same company. The CFO usually pulls profit and loss statements from the system which means this person will receive tutorials how to do that. The bookkeeper records receipts and creates invoices on a daily basis which means that tutorials speaking about this work are displayed. A warehouse manager pulls inventory reports and creates export invoices from the accounting software system and will therefore receive tutorials speaking about this. The same software has different people with different needs. The customization of the tutorials may also be used in any type of educational environment whereas different people on different levels of knowledge can be helped at the level each individual is at.

5: The user is asked if they wish to use the system with a sample database or with a file that they wish to upload into the software they are going to use. The difference is that if the user wants to upload a file it will be the SaaS version of the platform, vs. the simplified demo platform with no capabilities to upload, download, or save work that has been done in the online session.

6: If the user chose not to use any file of their own, but simply try the software application, all data that is put into the application when testing the software will be erased once the session is over. This will be version 1 (demonstration product) described in the document.

7: If the user chose the up/download function, the system enables the save function and the ability to return to the session using the same data that has been added or inputted into the application. There must be a personal profile setup for the user enabling the storage of files. Additional terms and condition will apply. The user will receive an email with the username/password and a link to the profile.

8: Once the user has logged into their profile, files can be uploaded, downloaded, and used in the online session. The user can come back to their session without losing any data. The ISV decides how long time the user can store their data (keep its profile) and how much data the user can upload and store.

9: The online session starts, using all features explained in the PRODUCT DESCRIPTION.

10: As soon as the online session starts, the system keeps track of how long time the user has been using the software application. If the user has created a profile and returned to the session, the number of returned sessions will be recorded together with each individually recorded numbers of seconds/minutes per session. This data is provided in the intelligence report to the ISV after the session is complete (12).

11: A few minutes into the session, a pop-up menu will appear with questions (Studio Questions). The questions may reflect the user's opinion about the software or if they have tried certain tools in the software. This is an optional feature for the ISV. Every user will be exposed to this usability survey.

12: Once the session is over a pop-up menu will appear with questions (Studio Questions). The questions may reflect the user's opinion about the software or if they have tried certain tools in the software. This is an optional feature for the ISV. Every user will be exposed to this usability survey.

13: Additional data about the user will be offered for an extra fee. If the ISV wishes to have information extracted from social media, credit reports, criminal reports, etc., this will be offered and the services will be either acquired from sub-vendors or directly from open online databases.

14: When the session is completed and closed, all data is compiled into an intelligence report delivered back to the ISV. The report includes contact information of the user, what the user liked about the software (studio questions), date and time when the demonstration was made, how long time the user spent using the software and—in some cases—what they did in the software. The data in the intelligence report vary from software application to software application, and from ISV to ISV, depending on what kind of questions has been asked in the prospect management module as well as in the studio questions. The intelligence report is delivered to the vendors sales and marketing department so they can follow up the customer. The intelligence report is delivered back to the ISV either as an email or direct into a CRM system. The ISV will be billed a certain amount for the lead information that is provided back to them also referred to as PayPerDemo (PPD).

15: When a session is being closed, before the end of the session the system will ask the user if they wish to save their work. There will be 3 options.

16: If the user answers YES to the question above (14), and does not have a profile, it will bring the user back to step 7 to setup a personal profile in the system, enabling them to up/download and save files.

17: If the user answers YES to the question above (14), the data from the session will be saved and the program will exit [will only apply to users with profiles, see item 7].

18: If the user answers NO to the question above (14), the session is closed. All data transacted in this particular session will be erased.

19: Optional for the ISV. The last part will be a landing page at the ISVs website.

### Data Collection

This is a selection of data that can be collected from the user during the process explained above. Questions are different from application to application, and from ISV to ISV. They are decided by the ISV depending on what they wish to have added into the intelligence report:
Prospect Management
   Who the user is
   What they work with
   Where they are located
   Their experience using this software
   Language selection
Studio questions during and after the session is over.
   What they did
   what they liked
   if they tried certain tools
   the quality of the demonstration
How long time the user spent using the software application.

### Data Delivery

The ISV will receive an intelligence report after each completed session (8). The data can either be sent directly into the ISVs CRM system or delivered as individual emails. The data can be delivered immediately after the session ends, or on a daily/monthly basis.

### Time Out

If and when the system is idle for a number of minutes, it will close down. To make sure data is not lost for registered users, it will be auto saved on their profile before the session closes down. The non-registered users will lose all data once the session is closed.

### Concurent Users (CCU)

Simple virtual machines (VM's) only provide one-by-one sessions: We enable the system to share resources and run parallel instances (sessions) on the same VM on the platform. The system will have to be built so it can scale to as many CCU's as the ISV wishes to have. The more CCU's, the more hardware power is necessary.

### Server Software Applications

Simple virtual machines (VM's) only provide an online demonstration for desktop software applications. This invention allows the system to install server software applications with additional and connected client/desktop applications to show how server software interacts with its clients in a real environment. A tab will display the server software and additional tabs the clients that are controlled by the server. When actions are made in the server software that affects a client, the actions can be seen immediately when clicking the client tab. This way the system showcases how server and client software interacts together in a cloud environment.

### Connectivity

The session should be accessible by all WIN OS (including mobile), APPLE OS running Windows, Android, iPhone, iPad.

### Pay Per Demo

The online demonstration session starts once the prospect management questions are completed by the user. The system will automatically compile all user data from the online session into an intelligence report. This report is delivered to the ISV. Delivery of the intelligence report is the billing mechanism to the ISV. Other embodiments may include a time requirement. Delivery of the intelligence report is the point of payment by the ISV. The intelligence report may or may not include the mid-session or end session questions depending on the amount of time the user spent on the online demonstration session.

### Scenario 1

A user does not answer the questions in the prospect management module. In this scenario a report is not sent to the ISV and payment is not required from the ISV.

### Scenario 2

A user answers the questions in the prospect management module but do not run the online demonstration session. In this scenario, an intelligence report is created and sent to the ISV, the ISV is billed for the report, and a quantity of zero seconds of online demonstration session is reported

### Scenario 3

A user answers the questions in the prospect management module, start the online session but exit the session before the mid-session questions can be answered (if these questions are asked). In this scenario an intelligence report is created and sent to the ISV, the ISV is billed for the report, and the amount of seconds the user spent on the session is reported.

### Scenario 4

A user answers the questions in the prospect management module, start the session, and run the online session long enough to answer the mid-session questions (if these questions are asked). In this scenario an intelligence report is created and sent to the ISV, the ISV is billed for the report, and the amount of seconds the user spent on the online demonstration session is reported, and the answers to the mid-session questions is reported.

In scenarios two, three, and four, questions may or may not be asked after the session is completed [end-session questions]. In the event questions are asked and answered, they will be included into the intelligence report.

### Implementation Details

The web based administration console, hereinafter referred to as a DemoStudio (DS), is created to access, use and administrate software applications online thru a browser window. The software code may be built to work, for example, with Microsoft Corporation's Visual Studio® technologies. The console's software code enables services such as:

(1) software application packaging, whereas any type of software application can be installed at the console (platform) and be fully functional online at the same way as if it would have been installed on a local machine,
(2) Stage progresses, whereas a number of specialized tools based on the code can be utilized such as

a) Device Analytic Management (DAM) where the users device is checked if it is updated so it can run the DemoStudio. The Web Service identifies the user device and what kind and version of browser is used. In the event a user browser plug-ins are not updated and compatible with the web services; a message is relayed to the user prompting to update its system before using DemoStudio to accomplish maximum quality of the service.

b) Prospect Management (PM) where user data is collected, the user data is submitted to the management service web server and the data is stored in a Data Base Server.

c) Trigger emails (TE), where customized email messages are sent to the user based on information from the PM, Email service is installed at an Email server. The management service and web service send information to the Email Service. The Email service sends selected email based on Prospect management information. The selected text is stored in the Data Base Server.

d) Studio Questions (SQ), where customized usability questions are asked based on information from PM, the Web server executes a popup menu at the user device screen after a selected number of minutes from the time the user have used the software application. The popup menu includes one or several questions the users have to answer. Popup questions are based on HTML format. Popup information received by the Web service is submitted to the management service and stored in the Data Base server.

e) Time Management (TM) where each user session is timed from start to finish to finding out how long time the user worked with the software application. The Data Base Management server includes a session management table recording every session start and stop time.

f) Usability Studio (US) whereas every movement made in the software, by the user, is recorded and data is collected into a usability study database in which statistic information is created to understand what a user, or collectively what all users are doing when they are working in a software application. An analytic tool records each session from start to the end. The analytic tool is installed in the analysis server store the recorded data in one common FTP server.

(3) Multiple Users [concurrent users] can be administrated, whereas a great number of users, at the same time, use the same software application without waiting in turn that others finish their sessions. To accomplish the multi-user access at the same Virtual Machine [VM], Application Servers can use, for example, Citrix System's FlexCast desktop virtualization tool and/or various independent Management Architecture tools. The present invention's software code enables auto login for each user in applications, like Citrix Xen App and Xen Desktop, to enable the multi-user sessions for each VM. The code stores processed data in the Database during the various processes in the session. The code in the Application Servers is built in layers to allow compatibility to run vendor's software applications in different operative systems as well as on both mobile and stationary devices on internet.
(4) Independent Device Infrastructure (IDI), whereas the software code opens up the services to any device such as smartphones, PC, Apple, or any operative system such as Windows, Android; Mac OS, Linux, etc. The DemoStudio is powered through a web browser and the software application on the platform is independently operated by the user without using the user device drivers to run the software. It does not matter what operative system or hardware the user device originate from as long as the device have access to an internet connection and its browser software is updated and compatible with the platform.

### DemoStudio Functionality

Once the Prospect Management is completed, and the user device is checked and up-to-date, DemoStudio is launched in the user devices browser window;

1. Data Management Services identify the following information and submit it to the Data Collector Server:

a) What type of tutorials the user shall have in its DemoStudio based on information from the Prospect Management.

b) What type of trigger emails the user shall receive based on the information from the Prospect Management.

c) What kind of Studio Questions the user shall receive based on the information from the Prospect Management.

d) What kind of advertising the user shall receive based on the information from the Prospect Management.

e) What software application shall be displayed based on the URL link.

2. The Data Collettor Server identifies application VM's based, for example, on Flexcast technology. Other technologies may be used, now or in the future for this task.
3. The software application is shared to multiple Microsoft Active directory users.
4. The Data base server assigns one Microsoft Active Directory user to each DemoStudio user, herein defined as “DemoStudio User”. The code predefines each DemoStudio User for each software application in the DemoStudio environment. The Data base server sends a common password to the Application Server the Web Server and the Database Server to access the vendors installed software application at the VM.
5. The Agent Service code is installed in agent Microsoft OS servers. The process of the Agent Service:

a. The Agent Service receives user login and application information from the Management service.

b. The Agent Service provides user login status (login/reconnect/disconnect/logoff) to the Management service.

6. The Management Service is installed in the Data Base server. The process of the Management Service:

a. The Management Service receives user data from the Web Service.

b. The Management Service receives user data from the Agent Service.

c. The Management Service receives user data from user login status and Agent Service auto user login to application servers.

d. The Management Service modifies and customizes the user session and store the data in the database.

7. A Data Collector Service (DCS) is installed in a Data collector server. The process of the DCS:

a. Application load balancing: The Vendor software application is installed on a minimum of two servers for balancing the application in the Application Server.

b. Sessions load balancing: The number of sessions of a software application is dimensioned with the configuration of hardware based on number of concurrent users and the complexity of functionality of the software application. Sessions are balanced, i.e. user 1 into server 1, user 2 into server 2, user 3 into server 1, user 4 into server 2, and so on.

8. The Web Service is installed in a Web server. The process of the Web Service:

a. The Web Service receives and forwards user data from the Prospect Management system to the Management Server.

b. The Web Service selects the skin [layout design of the DemoStudio service], the selected software application, the selected tutorials, the selected advertising to the user.

9. Email Service is installed in an email server. The process of the Email Service:

a. The Email Service sends user a verification email with a link to power up the session in the user device browser window.

b. A user verifies and confirms its identity by clicking on the link and the session start in the user device browser window.

Closed DemoStudio session: Once the DemoStudio session is closed, a few more Studio Questions will be asked in a popup menu as described under “Studio Questions” above. The web Service submits all information to the Data collector server through the Agent service.

Intelligence Report The Data Collector Server and Management Server will compile a report [Intelligence report] with all data collected before, during and after the DemoStudio session is closed.

10. Data collector and Application server information store in separate data base called a Data Collector Database.
11. The software code assigns different TCP port numbers when moving information/data from one service to another during the session.

What is claimed is:

1. A hosting system for providing access to online usage of software, comprising one or more servers set up to provide a platform having a virtual environment, the servers having vendor software uploaded and installed thereon for running by the servers in the virtual environment, the platform and its installed software being remotely accessible over a network to multiple simultaneous users who have provided user contact information.

2. The hosting system as in claim 1, wherein users provide their contact information via a prospect management page accessed from the platform over the network.

3. The hosting system as in claim 2, wherein the hosting system includes means for triggering electronic mail to the user based on the user contact information from and about a vendor of particular software accessed by that user on the platform.

4. The hosting system as in claim 2, wherein the contact information forms a basis for supplying a user-specific tutorial over the platform.

5. The hosting system as in claim 2, wherein the contact information forms a basis for generating user-specific questions for user feedback on the software.

6. The hosting system as in claim 2, wherein the contact information forms a basis for selecting specific advertisements that are displayed in the virtual environment to a specific user.

7. The hosting system as in claim 1, wherein the software is accessible to a user as a demonstration with user interaction with the software over the network in the virtual environment provided by the platform.

8. The hosting system as in claim 7, wherein how long a time a user spends using the accessed software is tracked and used as an item of feedback to the vendor of that particular software.

9. The hosting system as in claim 7, wherein the hosting system includes means for invoicing a vendor for each demonstration access by a user of its software.

10. The hosting system as in claim 1, wherein software is accessible to a user with fully functional interaction with the software over the network in the virtual environment provided by the platform, as a service.

11. The hosting system as in claim 1, wherein user interaction with specific software accessed over the network in the virtual environment provided by the platform is tracked so as to record which the user does with that software, including any one or more of what tools in the software are employed, how frequently such tools are used, and what kinds of key strokes are employed to make use of such software tools, said record being compiled for feedback and statistics to the vendor of the software for further software development.

12. The hosting system as in claim 1, wherein the virtual environment provided by the platform includes a display area for targeted advertising.

13. A computer server implemented method of providing access to online usage of software, comprising:
providing a platform having a virtual environment on one or more servers of a hosting system accessible to users over a network, the servers having vendor software uploaded and installed thereon for running by the servers in the virtual environment;
registering one or more users who provide user contact information to the platform, the platform supplying contact information to those vendors of the particular software accessed by each user; and
running vendor software selected by one or more simultaneous registered users, each user interacting remotely over the network with the software in the virtual environment provided by the platform.

14. The method as in claim 13, wherein users provide their contact information via a prospect management page accessed from the platform over the network.

15. The method as in claim 14, further comprising sending electronic mail to the user based on the user contact information from and about a vendor of particular software accessed by that user on the platform.

16. The method as in claim 14, further comprising supplying a user-specific tutorial in the virtual environment over the platform based upon supplied contact information of that user.

17. The method as in claim 14, further comprising generating user-specific questions in the virtual environment for user feedback on the software, wherein the questions are based upon supplied contact information of that user.

18. The method as in claim 14, further comprising displaying advertisements to the user in the virtual environment, where the specific advertisements for a specific user are selected based upon supplied contact information from that user.

19. The method as in claim 13, wherein the software is accessible to a user as a demonstration with user interaction with the software over the network in the virtual environment provided by the platform.

20. The method as in claim 19, wherein how long a time a user spends using the accessed software is tracked and used as an item of feedback to the vendor of that particular software.

21. The method as in claim 19, further comprising invoicing a vendor by the hosting system for each demonstration access by a user of its software.

22. The method as in claim 13, wherein the software is accessible over the network to a user as a service, the access provided to the user being fully functional interaction with the software in the virtual environment provided over the platform.

23. The method as in claim 13, further comprising tracking user interaction with specific software accessed over the network in the virtual environment provide by the platform so as to record what the user does with that software, including any one or more of which tools in the software are employed, how frequently such tools are used, and what kinds of key strokes are employed to make use of such software tools, said record being compiled for feedback and statistics to the vendor of the software for further software development

24. The method as in claim 13, further comprising, providing targeted advertising in a display area of the virtual environment.
